(19) United States
(12) Patent Application Publication
(10) Pub. No.: US 2007/0040848 A1
(43) Pub. Date: Feb. 22, 2007

(54) Fractal image data and image generator

(75) Inventors: John Edward Hutchinson, Yarralumla (AU); Michael Fielding Barnsley, Watson (AU); Orjan Stenflo, Stockholm (SE)

Correspondence Address: WOLF GREENFIELD & SACKS, PC, FEDERAL RESERVE PLAZA, 600 ATLANTIC AVENUE, BOSTON, MA, 02210-2206, US

(73) Assignee: The Australian National University, Austrailian Capital Territory (AU)

(21) Appl. No.: 10/549,416

(22) PCT Filed: Mar. 12, 2004
(86) PCT No.: PCT/AU04/00312

§ 371 Date: Oct. 23, 2006

(30) Foreign Application Priority Data
Mar. 14, 2003 (AU) 2003901237

(51) Int. Cl. G09G 5/00

(52) U.S. Cl. 345/629

(57) ABSTRACT

A fractal generation process, including: (i) randomly selecting images from a set of V>1 input images; (ii) selecting transformation functions from a set of transformation functions; (iii) generating transformed images by applying the selected transformation functions to the selected images; and (iv) generating an output image by combining the transformed images. Steps (i) to (iv) can be repeated to generate a set of V output images, and the entire sequence can be repeated using the set of V output images as a new set of V input images to generate a new set of output images. After a sufficient number of iterations, the new set of output images is substantially independent of the first set of input images used in the process. The resulting images represent V-variable fractals.

### FIELD OF THE INVENTION

The present invention relates to fractals, and in particular both to a new class of fractals and also to a fractal generator able to iteratively generate image data and a number of such fractals.

### BACKGROUND

Since the 1980's, fractals have been used to describe a wide variety of physical systems. Fractals can be generally classed as deterministic, if they can be generated by a deterministic process, or random, if the generation process uses one or more probability distributions to select iterated function systems. One of the best known applications of fractals is the simulation of natural formations occurring in the physical world, such as mountains, clouds, and waves. One of the difficulties of existing fractals and procedures for their generation is that deterministic fractals tend to be too rigidly deterministic, and random fractals too random, when these are compared with natural processes and forms occurring in the physical world. Deterministic fractals, while initially eye-catching, tend to lose the viewer's interest because they appear too repetitive. On the other hand, random fractals can also appear somewhat boring because the eye finds it hard to discern patterns, similar to the way that wispy white clouds can appear boring. These weaknesses are one of the factors that have limited the use of fractals in the content industries, in the areas of special effects in digital animation, computer games, and advertising, for example.

It is desired to provide at least a useful alternative, and in particular to provide image data representing at least a nascent fractal and a generator and process for generating the image data that alleviate one or more of the above difficulties.

### SUMMARY OF THE INVENTION

In accordance with the present invention, there is provided a V-variable fractal.

In particular, the present invention provides a V-variable fractal represented by fractal image data, where V is an integer greater than one and represents the number of constituent images available for iterative combination to generate the fractal. The images are combined in a random manner.

The present invention also provides image data representing a variable number n of constituent images iteratively transformed and combined in a random manner to generate said image data, with 1<n≦V.

The present invention also provides a fractal generation process, including:
(i) randomly selecting images from a set of input images;
(ii) selecting transformation functions from a set of transformation functions;
(iii) generating transformed images by applying the selected transformation functions to the selected images; and
(iv) generating an output image by combining the transformed images.

The present invention also provides a fractal generation process, including randomly selecting from a set of input images, transforming the selected images, and combining the transformed images to generate a set of output images, and iterative repetition of these steps using the set of output images of each iteration as the set of input images for the next iteration.

The present invention also provides a fractal generator, including:
an image selector for selecting M images from V input images;
a function selector for selecting a set of M transformation functions;
at least one image transformer for respectively applying the selected transformation functions to the selected input images; and
a compositor for composing an output image from the images output by said at least one image transformer.

The present invention also provides a fractal generation system, including an image selector for selecting images from a set of input images, and an image transformer for transforming the selected images to generate a set of output images, said system being adapted to provide said set of output images as the set of input images to iteratively generate fractal image data.

The present invention also provides fractal image data representing a combination of two or more constituent first images, each of said first images representing a random transformed combination of two or more constituent second images, each of said second images representing a random transformed combination of two or more constituent third images, each of said third images representing a random transformed combination of two or more constituent fourth images, wherein each transformation includes at least one of translation and rotation.

The present invention also provides image data decomposable into at least four successive levels, wherein each level is composed of smaller data sets which are affine transformations of V basic sets.

The present invention also provides image data representing iterative transformation and combination of at least two images selected from a set of V>1 input images, wherein image data generated at each iteration represents a combination of at least two smaller images, wherein each of said at least two smaller images represents an affine or projective transformation of image data generated at the previous iteration.

### BRIEF DESCRIPTION OF THE DRAWINGS

Preferred embodiments of the present invention are hereinafter described, by way of example only, with reference to the accompanying drawings, wherein:

FIG. 1 is a block diagram of a preferred embodiment of a fractal generation system;

FIG. 2 is a block diagram of a fractal generator of the fractal generation system;

FIG. 3 is a block diagram of an image transformer of the fractal generator;

FIG. 4 is a flow diagram of a fractal generation process executed by the fractal generation system;

FIG. 5 is a schematic diagram illustrating transformation of an input image by a transformation module of the image transformer;

FIGS. 6 to 10 are screenshots of images generated by the system using a first set of input parameters;

FIGS. 11 to 15 are screenshots of images generated by the system using a second set of input parameters; and

FIGS. 16 to 23 are screenshots of images generated by the system using a third set of input parameters.

### DETAILED DESCRIPTION OF THE PREFERRED EMBODIMENTS

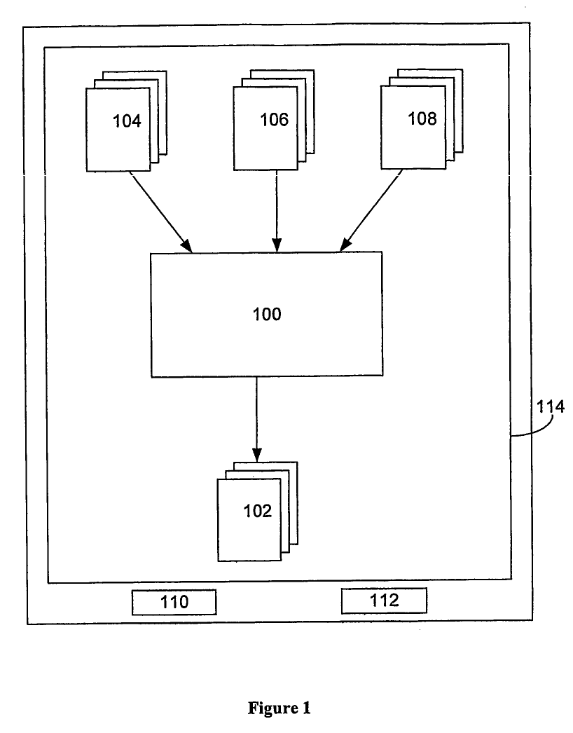

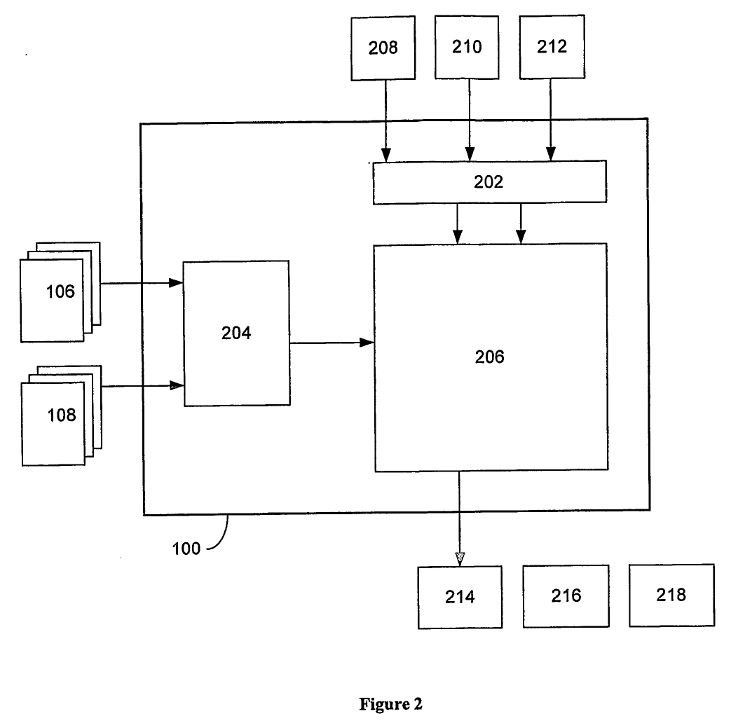

As shown in FIG. 1, a fractal generation system includes a fractal generator 100. As shown in FIG. 2, the fractal generator 100 includes an image selector 202, an iterated function system (IFS) selector 204, and an image transformer 206. The fractal generation system executes a fractal generation process that generates output image data 102 from input image data 104, iterated function systems 106, and selection probabilities 108. The input image data 104 constitutes a set of input images 104, and the output image data 102 constitutes two or more output images 102 that can be considered as representing two or more fractals or nascent fractals, as described below.

In the described embodiment, the fractal generation system is a standard computer system such as an Intel™ x86-based personal computer including a Pentium™ processor 110, random access memory (RAM) 112, and non-volatile (e.g., magnetic disk) storage 114, and the fractal generator is implemented by software modules stored on the non-volatile storage 114 of the computer and executed by the processor 110. However, it will be apparent that at least parts of the fractal generator can be alternatively implemented by dedicated hardware components, such as application-specific integrated circuits (ASICs).

The fractal generation system is described as generating output image data 102 from input image data 104. Although it is not necessary that the input and output data relate to images as such, i.e., the system processes these as arbitrary numeric data, it is expected that the system will be used to process input data and generate output data that in each case will be visualised as one or more images on a display or hardcopy. Accordingly, the input image data 104 is hereinafter referred to as input images 104, and the output image data 102 is hereinafter referred to as output images 102.

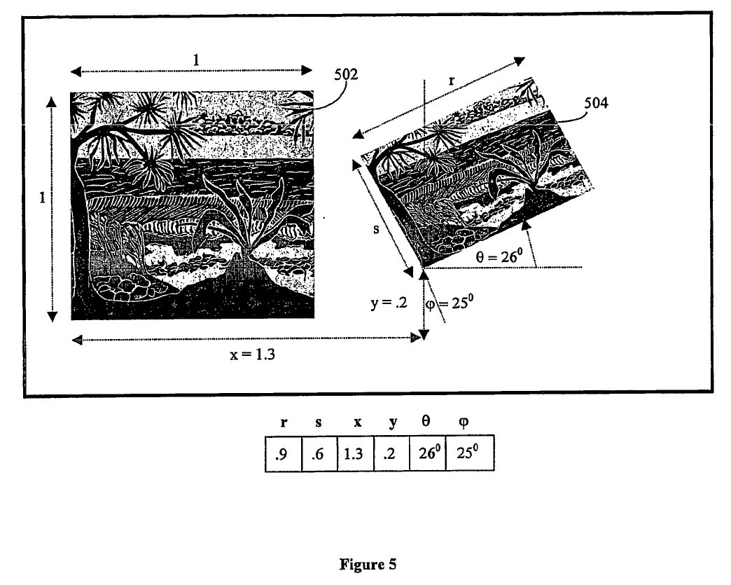

A user of the fractal generation system provides to the system a number V>1 (i.e., at least two) input images 104, together with N>1 iterated function systems F={F¹, . . . , F^{N}} 106 and N selection probabilities P={P¹, . . . , P^{N}} 108. Each of the N iterated function systems 106 comprises a set of M transformation functions. Each transformation function defines a contractive affine transformation that can be applied to an image, and is represented by the six parameters r, s, x, y, θ and φ_{.}, as described below. Alternatively, other types of transformations can be used, each represented by a corresponding set of parameters. As shown in FIG. 5, an input image 502 (in this case having horizontal and vertical dimensions of unity) is transformed by first scaling the horizontal and vertical dimensions of the input image 502 by the factors r and s, respectively, with −1<r<1 and −1<s<1, followed by translation along the x and y axes by the amounts specified by the x and y parameters, respectively, followed by a geometrical distortion whereby horizontal lines are rotated by the angle θ, and vertical lines are rotated by the angle φ, with −180≦θ≦180 and −180≦φ≦180. In FIG. 5, the angles θ and φ are nearly equal, and the output image 504 appears to retain its rectangular shape. However, when these two parameters are substantially unequal, a rectangular input image 502 is distorted to provide a generally parallelogram or diamond-like shape.

Because each transformation function is represented by the so transformation parameters described above, each iterated function system (IFS) 106, being a set of M transformation functions, can be represented as a parameter table 506 with M rows, each row representing a distinct transformation function. For example, an IFS 106 for M=3 can be represented as a 3×6 matrix or table, as follows:

| | | | | | |
|---|---|---|---|---|---|
| r₁ | s₁ | x₁ | y₁ | θ₁ | φ₁ |
| r₂ | s₂ | x₂ | y₂ | θ₂ | φ₂ |
| r₃ | s₃ | x₃ | y₃ | θ₃ | φ₃ |

Thus the iterated function systems 106 are provided as a set of N>1 parameter tables, each having M>1 rows. The N selection probabilities 108 are used to select a particular IFS (i.e., one of the N parameter tables) to apply to selected images, as described below.

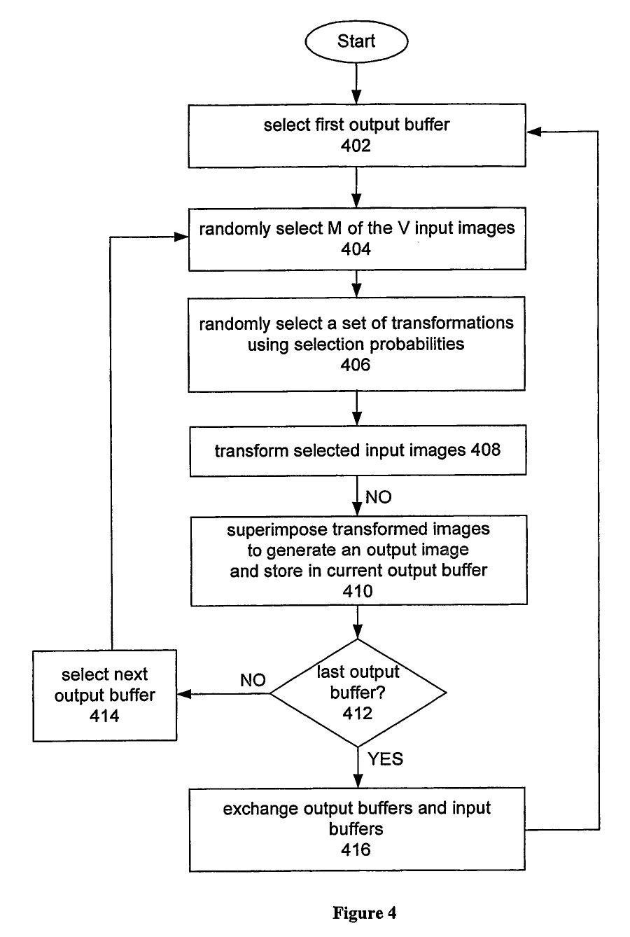

As shown in FIG. 2, the fractal generator 100 operates on a set of V input buffers 208 to 212, and a set of V output buffers 214 to 218 allocated from the computer RAM 112. Although FIG. 2 shows V=3 of each kind of buffer, there can be in general an arbitrary number V>1 of each buffer type, subject only to system constraints. The number of input images 104 provided to the system is less than or equal to the number V of input and output buffers, as the same image can be allocated to more than one buffer. The input images 104 are copied into the input buffers 208 to 212, and the fractal generator 100 then executes a fractal generation process, as shown in FIG. 4. The fractal generator 100 generates output images into each of the output buffers 214 to 218 in a sequential manner, starting with the first output buffer 214, and ending with the last output buffer 218. When the outermost loop of the fractal generation process is executed, all the output buffers 214 to 218 have been updated with new images, and an iteration of the process is said to have completed.

The fractal generation process begins at step 402, when the first output buffer 214 is selected to receive the first output image. At step 404, the image selector 202 randomly selects M of the V input images stored in the input buffers 208 to 212, with the same image allowed to be selected more than once. Accordingly, each time a selection is made, the probability of selecting the input image from a particular buffer is equal to 1/V, although it will be apparent that alternative selection methods can be used. The M selected images are provided to the image transformer 206. At step 406, the IFS selector 204 randomly selects one of the N IFSs 106 using the respective N selection probabilities 108. However, the random selection can be a biased quasi-random selection if desired. For example, the N selection probabilities 108 can be provided as respective weights used to divide the numeric interval between 0 and 1 into N contiguous subdivisions, where,the size of each subdivision is proportional to the weight for that subdivision. A random number between 0 and 1 can then be generated to select one of the N IFSs 106, according to which subdivision the random number falls within.

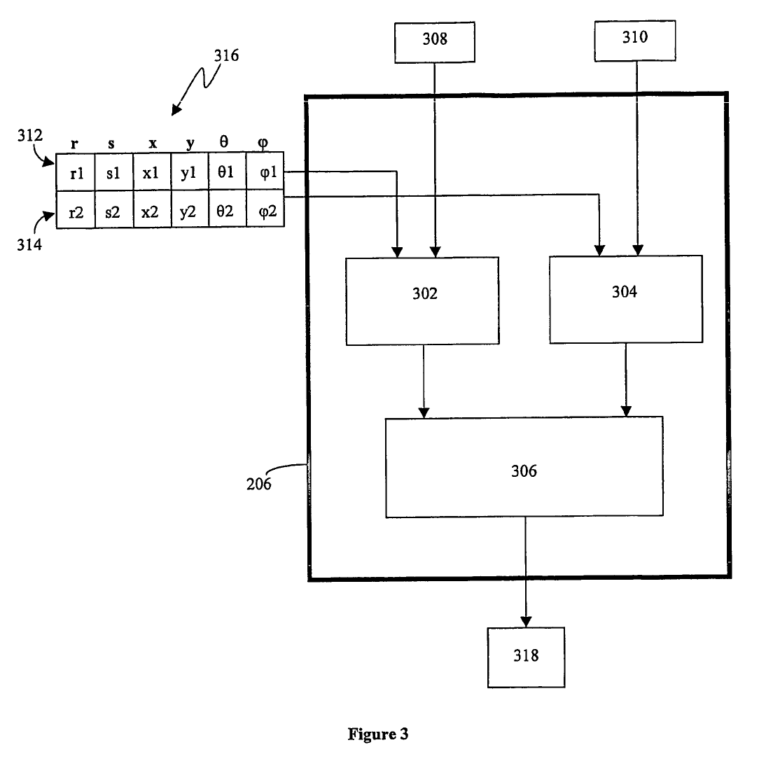

As shown in FIG. 3, the image transformer 206 includes M transformation modules 302, 304, and a superimpose module 306, shown for the example of M=2. At step 408, the transformation modules 302, 304 transform the selected input images using the selected IFS. The selected input images are transformed using respective transformation functions from the selected IFS. That is, the first transformation module 302 applies a first transformation function defined by the first row 312 of the selected parameter table 316 to the first selected input image 308. Similarly, the second transformation module 304 applies a second transformation function defined by the second row 314 of the selected parameter table 316 to the second selected input image 310.

Each of the transformation modules 302, 304 generates a transformed version of its input image, using the corresponding transformation function, as described above. It will be appreciated that, although distinct transformation modules 302, 304 are shown in FIG. 3, the M selected input images could alternatively be processed sequentially by a single transformation module. However, it may be particularly advantageous to provide distinct execution instances of each of the transformation modules 302, 304 if the system includes more than one processor or if the transformation modules 302, 304 are implemented as dedicated hardware components.

In the preferred embodiment, each of the input images 104 provided to the system by a user is a rectangular image with dimensions m×n utilising a rectangular co-ordinate system with origin 0,0 corresponding to one of the corners of the rectangular input image. Each of the transformed images generated by the transformation modules 302, 304 is maintained as an m×n image corresponding to the same spatial co-ordinates as the original input images 104. Accordingly, a given transformed image will generally include a number of transformed versions of previous images positioned within an otherwise empty m×n space within the particular transformed image. Any transformed images or parts of transformed images that fall outside the m×n co-ordinate space of a transformed image are cropped and are not included within the transformed image. Because each transformed image corresponds to the same m×n region of coordinate space, transformed images can be combined by superposition. However, it will be apparent that alternative embodiments can be devised such that a transformed image is not generated as an m×n rectangular image within the m×n coordinate space defined by input images 104, and the combining of images may involve only partial overlap of the constituent images, or may not involve any overlap at all.

At step 410, the resulting transformed images are processed by the superimpose module 306. This involves superimposing or overlaying the transformed images to generate a single output image 318. The superimposition is achieved by assigning to each pixel of the output image 318 a colour value (e.g., comprising a triplet of red, green, and blue (RGB) colour components) equal to the average of the colour values of the corresponding pixels of the transformed images. The resulting superimposed output image 318 is stored in the current output buffer, in this case the first output buffer 214.

It will be apparent that the transformed images can be combined in a variety of alternative ways. For example, the images can alternatively be combined by putting one down on top of the preceding one, one after another, so that only the last colour value written to each pixel is kept. Alternatively, a depth can be associated with each pixel in each image, for example, by adding another dimension to each image and increasing the parameter set from 2D to 3D, and then, when combining images, the frontmost pixel from the images being combined is the one that is used, as is done in 3D computer graphics, where a Z-buffer is used to select the frontmost pixels. Or alternatively, the exclusive or CXOR) of the first image and the second image can be used.

At step 412, a check is performed to determine whether the current output buffer is the last output buffer 218. If not, then the next output buffer, in this case the second output buffer 216, is selected at step 414, and the process returns to step 404 to randomly select another M images from the V input buffers 208 to 212, and subsequently generate another superimposed output image 318 for storage in the second output buffer 216 by executing steps 406 to 410. These steps are repeated until all the V output buffers 214 to 218 have been used to store respective new superimposed output images 318. Once the last output buffer 218 has stored an image, the test at step 412 succeeds, and an iteration of the process is complete. Rather than selecting another output buffer, the contents of the output buffers 214 to 218 are then used as input images to the next iteration of the process. This can be achieved by physically copying the contents of the output buffers 214 to 218 into the respective input buffers 208 to 212. However, it is more efficient simply to exchange, at step 416, the roles of the two sets of buffers by exchanging or swapping the corresponding buffer pointers into the random access memory 112. In any case, after the superimposed output images have been provided in respective input buffers 208 to 212 and the output buffers 214 to 218 have been cleared, the fractal generation process begins the next iteration by selecting the first output buffer 214 at step 402, and repeating the steps described above. As many iterations as desired can be performed.

The contents of one or more of the output buffers 214 to 218 can be displayed on a display device associated with the fractal generation system for viewing by the user. Individual images selected by the user or images generated by a user-specified number of iterations of the fractal generation process can be stored as final output images 102 on the non-volatile storage medium 114 for subsequent use. After a number of iterations, the output images 102 are a set of V-variable fractal images derived from the preceding input images. It will be appreciated by those skilled in the art that the although the image data generated by the fractal generation system is referred to as fractal image data, it may only represent a nascent fractal if the finite number of iterations of the fractal generation process are not sufficient to produce a fractal.

With successive iterations, the output images 318 become less dependent on the initial input images 104, and eventually become characteristic of the input parameter tables 106 and their selection probabilities 108. The images 318 generated by the system then form a diverse sample of an infinite collection of all possible images associated with the initial parameter tables 106 and probabilities 108. In particular, because the transformations are contractive, the original input images 104 for the first iteration will eventually be contracted to the size of a single pixel when the entire output image is viewed, given a sufficient number of iterations. Thus the output images become independent of the original input images 104. Accordingly, the input images 104 can be alternatively provided or generated by the system itself, rather than being provided by the user as input, and the value of V can be provided as input to the system. By adjusting the parameter tables 106, the appearance and form of the classes of images generated by the system can be modified. For example, one class of images might resemble a group of tea trees, another a collection of faces, and another might resemble (and be used to represent) possible stock market simulations. As a result, the possible applications of the fractal generation system and process are very broad and diverse.

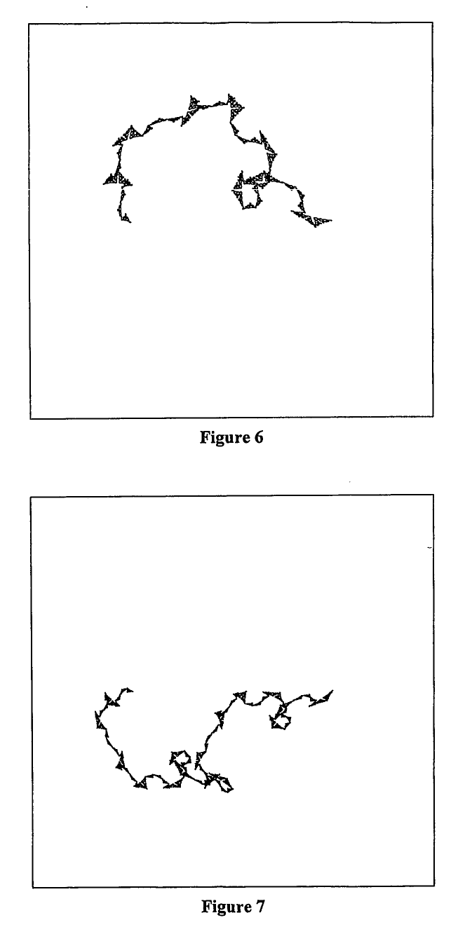

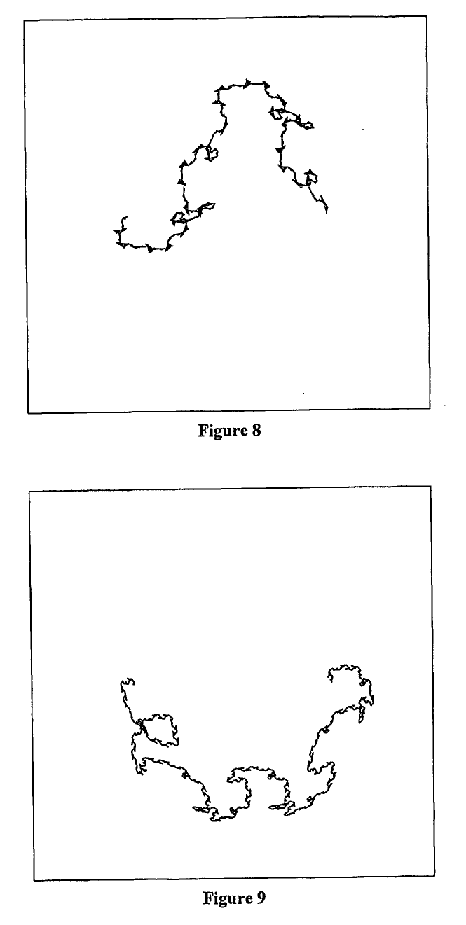

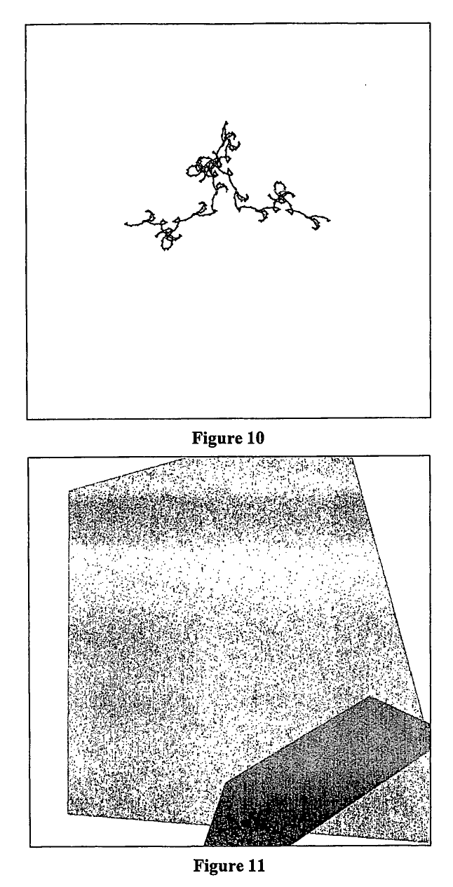

For example, FIGS. 6 to 10 are screenshots of images generated by the fractal generation system after 4, 5, 6, 11 and 44 iterations, respectively, using V=2 and the following input parameter tables:

IFS 1:

| | a | b | c | d | e | f |
|---|---|---|---|---|---|---|
| transformation 1: | 0.5 | −0.375 | 0.3125 | 0.5 | 0.375 | .1875 |
| transformation 2: | 0.5 | 0.375 | 0.1875 | −0.5 | 0.375 | .6875 |

IFS 2:

| | a | b | c | d | e | f |
|---|---|---|---|---|---|---|
| transformation 1: | 0.5 | −0.375 | 0.3125 | −0.5 | −0.375 | .8125 |
| transformation 2: | 0.5 | 0.375 | 0.1875 | 0.5 | −0.375 | .3125 |

In this example, each transformation is a contractive affine transformation defined by (x,y)→(ax+by+c, dx+ey+f), where the parameters a to f are as indicated in the parameter tables.

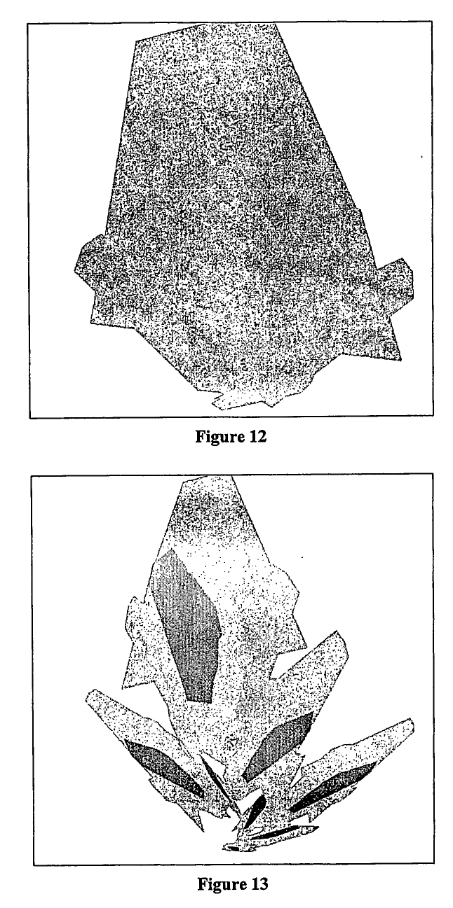

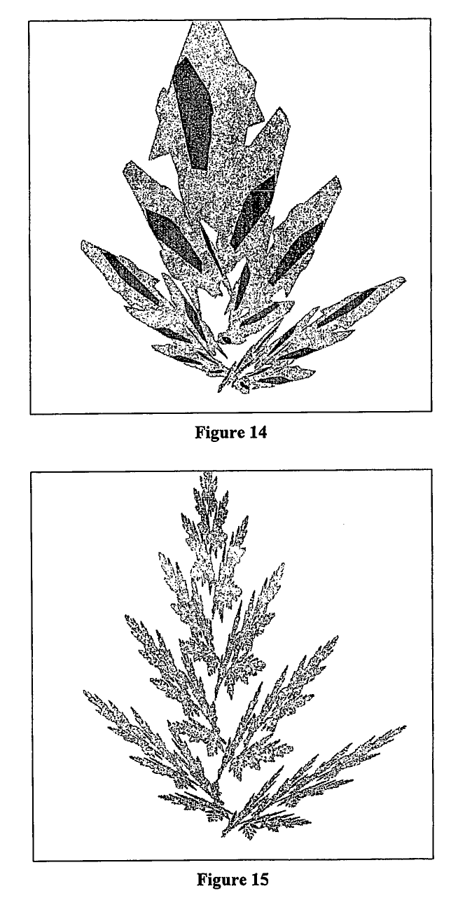

As a second example, FIGS. 11 to 15 are screenshots of fractal images generated after 1, 3, 6, 8, and 22 iterations, respectively, using V=2 and the following parameter tables:

IFS 1:

| a | b | c | d | e | f | g | h | I |
|---|---|---|---|---|---|---|---|---|
| .151827 | .034074 | −.215212 | −.123706 | −.246197 | .054262 | −.212523 | .059302 | −.234997 |
| .011248 | .011321 | −.000425 | −.001814 | −.026793 | .062591 | .014512 | −.057923 | .086631 |

IFS 2:

| a | b | c | d | e | f | g | h | I |
|---|---|---|---|---|---|---|---|---|
| .017380 | −.035039 | .046965 | .029178 | .006695 | .025663 | .021377 | −.012129 | .048469 |
| .144191 | .004070 | −.183496 | −.099432 | −.243409 | .043246 | −.151388 | .001065 | −.199968 |

In this example, each transformation is a contractive projective transformation defined by (x,y)→((ax+by+c)/(gx+hy+I), (dx+ey+f))/(gx+hy+I)), where the parameters a to I are as indicated in the parameter tables.

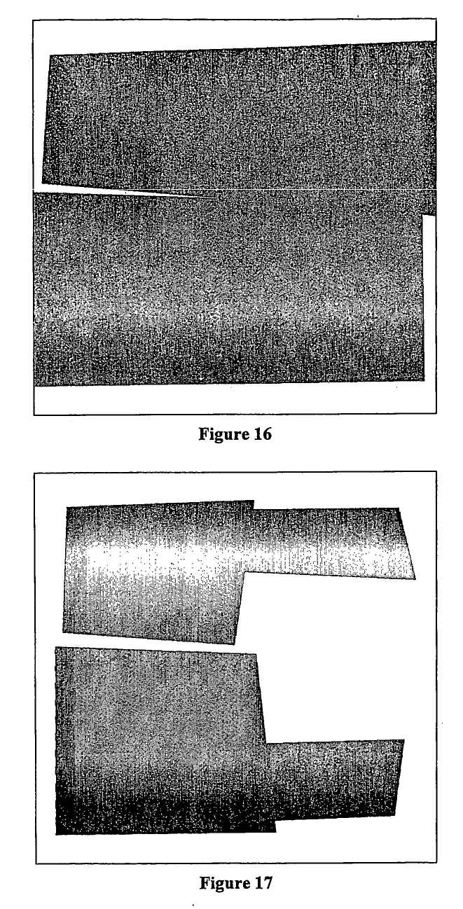

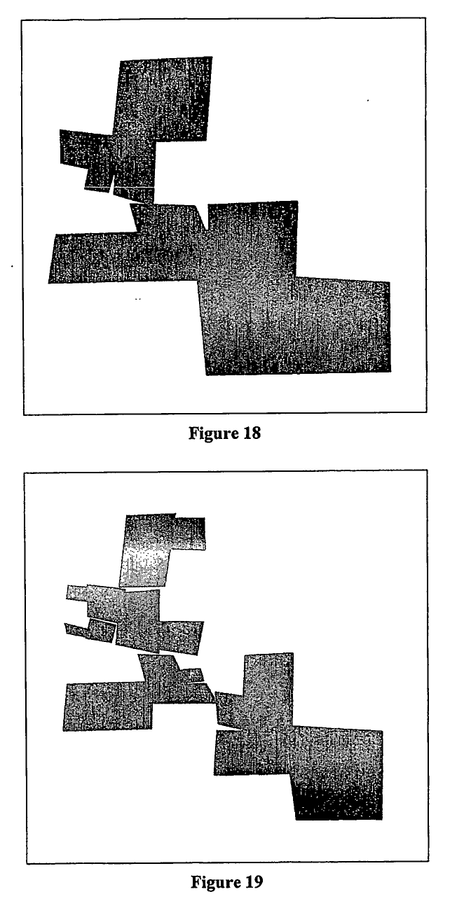

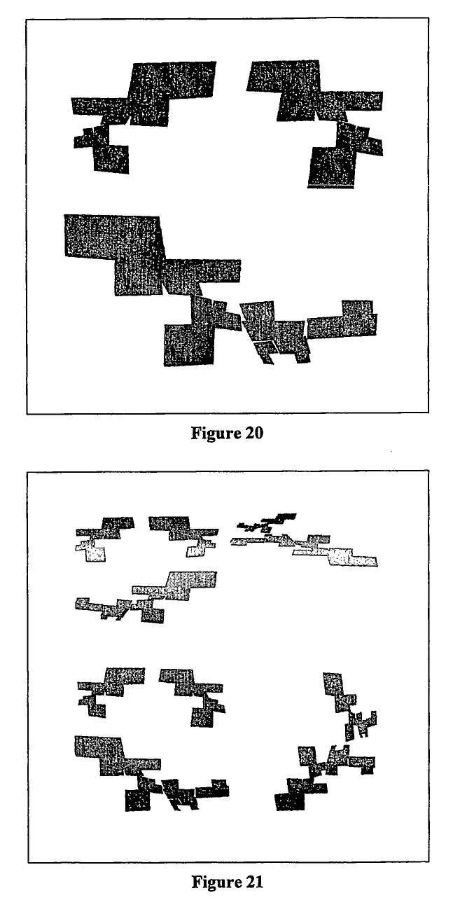

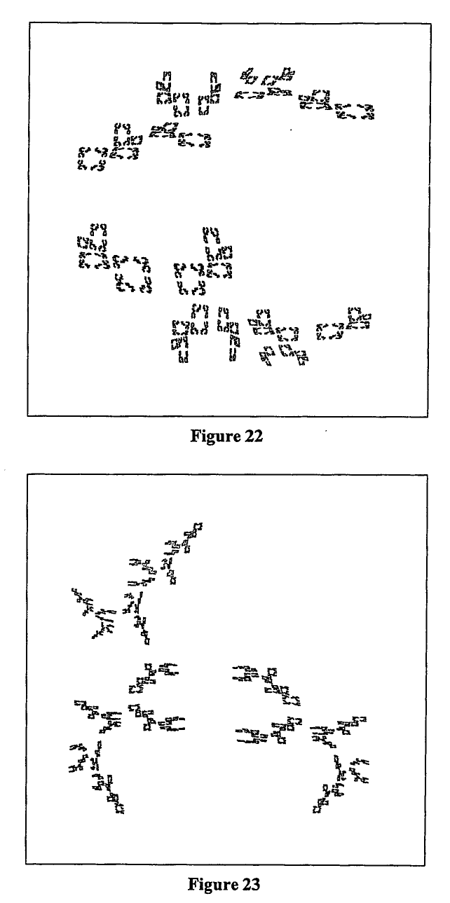

As a third example, FIGS. 16 to 23 are screenshots of images generated after 1, 2, 3, 4, 6, 8, 22, and 40 iterations, respectively, using the same projective transformation with V=2 and the following parameter tables:

IFS 1:

| a | b | c | d | e | f | g | h | I |
|---|---|---|---|---|---|---|---|---|
| .001231 | −.335970 | .002318 | −.164124 | −.028044 | −.125233 | .003548 | −.033609 | −.309261 |
| .002575 | .039210 | .007817 | −.045553 | −.005329 | .056137 | −.001851 | −.027965 | .126001 |

IFS 2:

| a | b | c | d | e | f | g | h | I |
|---|---|---|---|---|---|---|---|---|
| −.006211 | −.197079 | .208860 | .087110 | .013677 | .011083 | −.008298 | .075200 | .205408 |
| .003412 | .306195 | −.303822 | .141253 | .023639 | −.286545 | .001890 | .028936 | −.312419 |

The image data or images generated by the system represent a new type or class of fractals, referred to as V-variable fractals. As can be seen from FIGS. 6 to 23, they can be considered to be random fractals because they exhibit a degree of randomness, but this is intermediate between deterministic fractals and prior art random fractals generated by other methods. As such, they are able to represent natural forms more accurately than prior art fractals, and yet can be generated more readily than prior art random fractals.

An image representing a V-variable fractal can be characterised as follows. Each fractal image is a combination of at least two smaller images. There is a set of V basic images such that each of the smaller images represents a contractive affine transformation of a basic image from the set of V basic images. The V basic images and the contractive affine transformations provide the first level of decomposition of the image representing the V-variable fractal. Each of the two or more smaller images from the first level of decomposition is itself a combination of at least two smaller again images and there is a second set of V basic images such that each of the smaller again images represents a contractive affine transformation of a basic image from the second set of basic images. The second set of V basic images and the corresponding contractive affine transformations provide a second level of decomposition of the image represent the V-variable fractal. These decompositions can be continued for at least four levels of decomposition. However, if every set of basic images contains just one distinct basic image, then the representing image is a deterministic or random fractal of a previously known type, and as such is not included in the new class of fractals.

It will be apparent to those skilled in the art that the affine transformations in the above description can be replaced by projective transformations or certain other classes of transformations. These classes have the property that when any two transformations from the class are applied one after another, a new transformation in the same class is obtained.

FIGS. 6 to 10, 13 to 15, and 19 to 23 are examples of V-variable fractal images where V=2. Each of these images was generated by four or more iterations of the fractal generation process. At each scale there are at most V non-equivalent sets. These sets can be combined partially or wholly one on another. The sets typically change from magnification level to magnification level. While V=2 in FIGS. 6 to 23, larger values of V can be used.

The properties of V-variable fractals are described in more detail in M. Barnsley, J. Hutchinson and Ö. Stenflo, A Fractal Valued Random Iteration Algorithm and Fractal Hierarchy, available at http://arxiv.org/abs/math.PR/0312187; and in M. Barnsley, J. Hutchinson and Ö. Stenflo, V-variable fractals and superfractals at http://arxiv.org/abs/math.PR/0312314.

The fractal generation system has been described above in terms of contractive affine geometrical transformation and superimposition of two-dimensional images. However, it will be apparent that the iterated function systems 106 can include other function systems that can be used to modify the input image data 104. For example, the iterated function systems 102 can include contractive projective transformations, or affine transformations that are contractive on average, where the average is determined by the probabilities 108 associated with the iterated function systems 106. Because the system generates output images by combining multiple, transformed copies of input images, contractive transformations are preferably used in order to limit the output image size when translated and/or rotated images are combined, and this is preferably limited to the size of the input images. However, the transformations can alternatively be contractive on average, as described above. Similarly, it will be apparent that the transformed images can be combined by methods other than superposition, as described above. Moreover, the fractal generation process can be applied to image data representing three-dimensional images to generate a new class of three-dimensional fractals, or indeed to input data of even higher dimensionality. The image data need not represent an existing image or be used to generate an image, but can be used for any desired purpose.

In an alternative embodiment, the transformation modules 302, 304 can modify the colour and/or brightness of input images, in addition to the geometrical transformations described above. These additional modifications are defined by additional parameters included in the parameter tables 106. When the modifications of colour and/or brightness are performed in a contractive manner, the output images generated by the system, after a small number of iterations, depend only on the input parameter tables 106 and their selection probabilities 108. If the brightness of an image is represented by a number z, then an example of a contractive transformation of brightness z is new_z=p*z+q where |p|<1 and q is a constant. Contractive transformations of colour are achieved by three contractive transformations of brightness, one for each of the red, blue and green colour components.

In a further embodiment, the parameter tables are generated graphically. For example, an affine transformation can be characterised by how it transforms a given triangle into another triangle. For example, a user can use a pointing device (such as a mouse) to drag the vertices of a given triangle to new positions and thereby define an affine transformation.

In yet a farther alternative embodiment, the parameter tables 106 and selection probabilities 108 are themselves generated from predetermined probability distributions, such as normal distributions, using a random number generator.

It may be appreciated that the new class of V-variable fractals, realised as images or in any digital form, may also be generated by processes other than those described above. For example, those skilled in the art will realise that for the generation processes described herein, which correspond to forward methods, there are also corresponding backward methods, although such methods will be less efficient for generating V-variable fractals.

Many modifications will be apparent to those skilled in the art without departing from the scope of the present invention as herein described with reference to the accompanying drawings.

1. A fractal generation process, including:
(i) randomly selecting images from a set of input images;
(ii) selecting transformation functions from a set of transformation functions;
(iii) generating transformed images by applying the selected transformation functions to the selected images;
(iv) generating an output image by combining the transformed images;
(v) repeating steps (i) to (iv) to generate a set of output images; and
(vi) repeating steps (i) to (v) using said set of output images as said set of input images to generate a new set of output images.

2. A fractal generation process as claimed in claim 1, wherein said output images represent respective fractals.

3. A fractal generation process as claimed in claim 2, including repeating step (vi) until said new set of output images is substantially independent of the first set of input images used in the process.

4. A fractal generation process as claimed in claim 1, wherein the number of selected transformation functions is less than the number of transformation functions in said set of transformation functions.

5. A fractal generation process as claimed in claim 1, wherein the step of selecting transformation functions includes selecting an iterated function system from a set of iterated function systems, each iterated function system including a set of transformation functions.

6. A fractal generation process as claimed in claim 5, wherein the selection of an iterated function system is based on selection probabilities associated with said iterated function systems.

7. A fractal generation process as claimed in claim 1, wherein the combining of said transformed images includes superimposing said transformed images.

8. A fractal generation process as claimed in claim 1, wherein said transformation functions include geometrical transformations.

9. A fractal generation process as claimed in claim 8, wherein said geometrical transformations include scaling and translation.

10. A fractal generation process as claimed in claim 8, wherein said geometrical transformations include scaling, translation and geometrical distortion.

11. A fractal generation process as claimed in claim 1, wherein said geometrical transformations are contractive transformations.

12. A fractal generation process as claimed in claim 1, wherein said transformation functions include projective transformations.

13. A fractal generation process as claimed in claim 1, wherein said transformation functions include transformations of at least one of brightness and colour.

14. A fractal generation process as claimed in claim 1, wherein each of said transformation functions is represented by one or more parameters.

15. A fractal generation process as claimed in claim 6, including generating said transformation functions and said selection probabilities.

16. A fractal generation process as claimed in claim 15, wherein said transformation functions and said selection probabilities are generated on the basis of one or more predetermined probability distributions.

17. A fractal generation process as claimed in claim 1, including generating said set of input images.

18. A fractal generation process, including randomly selecting from a set of input images, transforming the selected images, and combining the transformed images to generate a set of output images, and iterative repetition of these steps using the set of output images of each iteration as the set of input images for the next iteration.

19. A fractal generation process as claimed in claim 18, wherein said selecting includes selecting the same input image more than once.

20. A fractal generation process as claimed in claim 18, wherein said transforming includes scaling and translating the selected images.

21. A fractal generation process as claimed in claim 20, wherein said transforming also includes geometrically distorting the selected images.

22. A fractal generation process as claimed in claim 18, wherein the transforming is contractive.

23. A fractal generation process, including:
(i) randomly selecting images from a set of input images;
(ii) transforming the selected images; and
(iii) combining the transformed images to generate a set of output images;
wherein steps (i) to (iii) are repeated iteratively using the set of output images of each iteration as the set of input images for the next iteration, each output image providing a new fractal.

24. A system having components for executing the steps of claim 1.

25. A computer readable storage medium having stored thereon program instructions for executing the steps of claim 1.

26. Image data generated by a process as claimed in claim 1.

27. Image data as claimed in claim 26, wherein said image data represents one or more V-variable fractals.

28. A fractal generator, including:
an image selector for selecting M images from V input images;
a function selector for selecting a set of M transformation functions;
at least one image transformer for respectively applying the selected transformation functions to the selected input images; and
a compositor for composing an output image from the images output by said at least one image transformer;
wherein the fractal generator is configured to iteratively generate sets of V output images using the set of V output images of each iteration as the set of V input images for the next iteration.

29. A fractal generator as claimed in claim 27, wherein said function selector is adapted to select said set of M transformation functions from N sets of transformation functions.

30. A fractal generation system, including an image selector for selecting images from a set of input images, and an image transformer for transforming the selected images to generate a set of output images, said system being adapted to provide said set of output images as the set of input images to iteratively generate fractal image data.

31. A fractal generation system as claimed in claim 30, wherein said image transformer includes one or more image transformation modules for transforming said selected images, and an image combination module for combining the transformed images.

32. A fractal generation system as claimed in claim 31, wherein said one or more image transformation modules are adapted to scale and translate said selected images.

33. A fractal generation system as claimed in claim 32, wherein said one or more image transformation modules are adapted to geometrically distort said selected images.

34. A fractal generation system as claimed in claim 30, including a transformation selection module to select transformations to be applied to the selected images from a set of transformations.

35. A fractal generation system as claimed in claim 34, wherein said transformation selection module is adapted to select transformations based on selection probabilities associated with said set of transformations.

36. Fractal image data representing a combination of two or more constituent first images, each of said first images representing a random transformed combination of two or more constituent second images, each of said second images representing a random transformed combination of two or more constituent third images, each of said third images representing a random transformed combination of two or more constituent fourth images, wherein each transformation includes at least one of translation and rotation.

37. Fractal image data as claimed in claim 36, wherein each transformation is a projective transformation, such as an affine transformation.

38. Fractal image data as claimed in claim 37, wherein each transformation includes contractive scaling.

39. Fractal image data as claimed in claim 37, wherein the transformations are contractive on average.

40. Fractal image data as claimed in claim 36, wherein each combination is a superposition.

41. Image data representing a variable number n of constituent images randomly selected from a set of V images and iteratively transformed and combined in a random manner to generate said image data, with V>1 and 1<n<V.

42. Image data as claimed in claim 41, wherein the constituent images are transformed using projective transformations at each iteration.

43. A V-variable fractal.

44. A V-variable fractal as claimed in claim 43, wherein said V-variable fractal is represented by fractal image data, where V is an integer greater than one and represents the number of constituent images available for iterative combination to generate the fractal.

45. Image data decomposable into at least four successive levels, wherein each level is composed of smaller data sets which are affine transformations of V basic sets.

46. Image data as claimed in claim 45, wherein the basic sets vary from level to level.

47. Image data as claimed in claim 45, wherein the transformations are contractive.

48. Image data as claimed in claim 45, wherein each of said data sets comprises a set of V>1 images.

49. Image data representing iterative transformation and combination of at least two images selected from a set of V>1 input images, wherein image data generated at each iteration represents a combination of at least two smaller images, wherein each of said at least two smaller images represents an affine or projective transformation of image data generated at the previous iteration.

50. Image data representing a V-variable fractal, wherein V is an integer greater than one that determines the maximum number of basic images that can be generated by:
(i) selecting constituent images of said image data;
(ii) applying one or more projective transformations to each of the constituent images to provide basic images;
(iii) selecting constituent images of the basic images; and
(iv) iteratively repeating steps (ii) and (iii) to provide a set of basic images from which said image data can be generated by iterative random selection, transformation and combination;
wherein one or more first basic images that can be generated by affine transformation of a second basic image are considered to provide one basic image.

51. Image data decomposable into a set of basic images by:
(i) selecting constituent images of said image data;
(ii) applying one or more projective transformations to each of the constituent images to provide basic images;
(iii) selecting constituent images of the basic images; and
(iv) iteratively repeating steps (ii) and (iii) to provide said set of basic images from which said image data can be generated by iterative random selection, transformation and combination.

52. Image data as claimed in claim 51, wherein at least four iterations are performed.

53. Image data as claimed in claim 51, wherein the one or more projective transformations are selected to provide the minimum number of basic images.
